(19) United States
(12) Patent Application Publication
(10) Pub. No.: US 2025/0024314 A1
(43) Pub. Date: Jan. 16, 2025

(54) QOS CONTROL METHOD

(71) Applicant: MEDIATEK Inc., Hsinchu City (TW)

(72) Inventors: Han-Cheng SHIH, Hsinchu City (TW); Ming-Han TU, Hsinchu City (TW); Yuan-Chin WEN, Hsinchu City (TW)

(21) Appl. No.: 18/744,763

(22) Filed: Jun. 17, 2024

Related U.S. Application Data
(60) Provisional application No. 63/513,583, filed on Jul. 14, 2023.

(51) Int. Cl. H04W 28/02; H04W 24/08

(52) U.S. Cl. CPC H04W 28/0268; H04W 24/08

(57) ABSTRACT

A method for controlling QoS (quality of service) associated with an application is provided. The method includes the following steps. Obtaining a predicted throughput of a wireless link associated with a wireless transceiver. Obtaining a currently measured throughput of the wireless link. Calculating a throughput budget of the wireless link based on the predicted throughput and the currently measured throughput. Adjusting at least one of a plurality of QoS-related parameters associated with the application base on the throughput budget.

This application claims the benefit of U.S. provisional application Ser. No. 63/513,583 filed at Jul. 14, 2023, the disclosure of which is incorporated by reference herein in its entirety.

### TECHNICAL FIELD

The disclosure relates to a control mechanism, and particularly relates to a method for controlling QoS (quality of service).

### BACKGROUND

With the progress of communication technology, wireless transceivers have achieved better performance. Correspondingly, upper layer applications, which process data content transmitted by the wireless transceivers, have achieved better quality.

However, performance of wireless transceivers may greatly vary with factors, e.g., interference and collision, etc. Therefore, quality of service (QoS) for the upper layer applications may be easily influenced. The QoS for the applications must be adjusted in a real-time manner so as to match the best capability of the wireless transceivers.

In view of the above issue, it is desirable to have a QoS control method, which can adjust QoS-related parameters for the applications in a real-time manner to fit current capability of the wireless transceivers.

### SUMMARY

According to one embodiment, a method for controlling QoS (quality of service) associated with an application is provided. The method includes the following steps. Obtaining a predicted throughput of a wireless link associated with a wireless transceiver. Obtaining a currently measured throughput of the wireless link. Calculating a throughput budget of the wireless link based on the predicted throughput and the currently measured throughput. Adjusting at least one of a plurality of QoS-related parameters associated with the application base on the throughput budget.

According to another embodiment, a method for controlling QoS (quality of service) associated with an application is provided. The method includes the following steps. Obtaining a predicted throughput of a wireless link associated with a wireless transceiver. Obtaining a currently measured throughput which is a real-time information of the wireless link, by a monitoring unit of a firmware in a real-time manner. Calculating a throughput budget of the wireless link based on the predicted throughput and the currently measured throughput. Adjusting at least one of a plurality of QoS-related parameters associated with the application base on the throughput budget. The firmware is a lower layer in a stack of a device operating the application, and the application is an upper layer in the stack.

### BRIEF DESCRIPTION OF THE DRAWINGS

FIG. 1 illustrates a schematic diagram of an operating environment for a QoS (Quality of Service) control method according to an embodiment of the disclosure.

FIG. 2 illustrates a functional block diagram of the source device 1000 and the target device 2000 in the operating environment of FIG. 1.

FIG. 3 illustrates a timing diagram showing waveforms of a currently measured throughput Tput(ti), a predicted throughput Tput_P(ti) and a maximum transmission rate Rt_max.

FIG. 4 illustrates a schematic diagram of the SW/FW/HW stack of the source device 1000.

FIG. 5 illustrates a flow diagram of the QoS control method according to an embodiment of the disclosure.

FIG. 6 illustrates a timing diagram showing operations of the transmitter (TX) and the receiver (RX) of the wireless transceiver 100.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

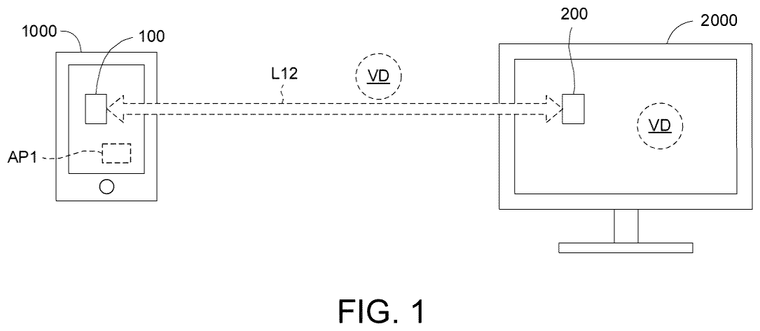

FIG. 1 illustrates a schematic diagram of an operating environment for a QoS (Quality of Service) control method according to an embodiment of the disclosure. Referring to FIG. 1, the operating environment includes a source device 1000 and a target device 2000. The source device 1000 is communicatively coupled to the target device 2000 through a wireless link L12. The source device 1000 may be a mobile computing device, e.g., a smart phone, while the target device 2000 may be a display device, e.g., a smart TV. The source device 1000 and the target device 2000 are equipped with wireless transceivers 100 and 200 respectively. The wireless transceivers 100 and 200 are, e.g., WiFi transceivers, and the wireless link L12 is dedicated to data transmission conforming to the IEEE 802.11 family of standards.

The source device 1000 may execute an application AP1 to process an object data. For example, the application AP1 is a media player application and the object data is a video data VD. The application AP1 of the source device 1000 may perform a mapping function for the video data VD to the target device 2000, such that the video data VD may be provided to and displayed on the target device 2000.

The quality of the video data VD, when displayed on the target device 2000, may be influenced by the performance of the wireless transceivers 100 and 200. When the wireless transceivers 100 and 200 achieve better performance and the wireless link L12 hence achieves an increased throughput Tput, the quality of the video data VD may be therefore enhanced. For example, when the source device 1000 and the target device 2000 have a shorter distance and the wireless transceiver 200 of the target device 2000 hence achieves a greater Received Signal Strength Indication (RSSI), the wireless link L12 may have a greater throughput Tput, and the video data VD may be displayed more fluently (e.g., with shorter latency) on the target device 2000 with a better quality. In the QoS control method of the disclosure, the source device 1000 and/or the target device 2000 may measure the throughput Tput of the wireless link L12 in a real-time manner (i.e., the measured throughput Tput is a real-time information obtained by the wireless transceiver 100, in a real-time manner). Some QoS-related parameters may be adjusted based on the measured throughput Tput. The QoS-related parameters are related to quality of video data VD, which is associated with the application AP1.

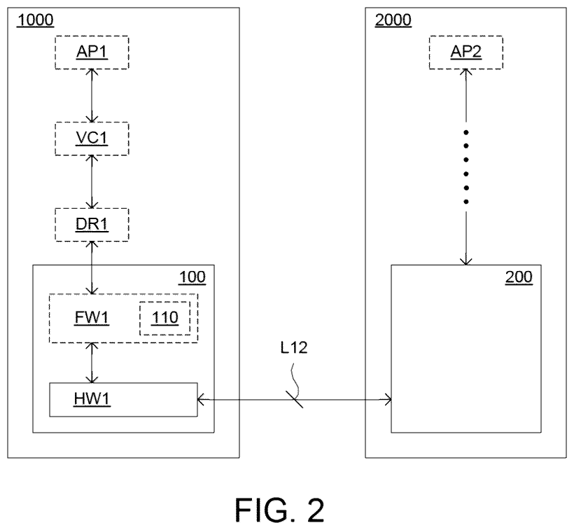

FIG. 2 illustrates a functional block diagram of the source device 1000 and the target device 2000 in the operating environment of FIG. 1. Referring to FIG. 2, each of the source device 1000 and the target device 2000 may operate with a stack of software, firmware and hardware (referred to as a “SW/FW/HW stack”). Taking the source device 1000 as an example, the SW/FW/HW stack of the source device 1000 includes a layer of application AP1, a layer of vendor command VC1, a layer of driver DR1, a layer of firmware FW1 and a layer of hardware HW1. More particularly, the application AP1 is an upper-layer application framework, e.g., a media player application as aforementioned. Furthermore, the layer of vendor command VC1 and the layer of driver DR1 are related to the kernel of operating system (e.g., a Linux kernel) of the source device 1000. The layer of driver DR1 (e.g., “WiFi driver nic”) is a driver for the wireless transceiver 100. The layer of vendor command VC1 (e.g., “NL80211_VENDOR_SUBCMD”) is an interface between the application AP1 and the driver DR1. In addition, the layer of firmware FW1 and the layer of hardware HW1 are related to the wireless transceiver 100. The firmware FW1 is a lower-layer firmware for directly controlling the circuitry components in the hardware HW1.

Likewise, the target device 2000 may have a similar SW/FW/HW stack which includes an application AP2 and other layers (not shown in FIG. 2). The application AP2 of the target device 2000 is similar to the application AP1 of the source device 1000, the application AP2 is also an upper-layer application framework. When performing the QoS control method of the disclosure, the application AP1 and/or the application AP2 may adjust some QoS-related parameters for the video data VD based on the currently measured condition of the wireless link L12. The layer of firmware FW1 may include a monitoring unit 110 for monitoring the condition of the wireless link L12 in a real-time manner. Such as, the monitoring unit 110 may control some circuitry components of the hardware HW1 to real-time measure the throughput Tput of the wireless link L12, so as to obtain a currently measured throughput Tput(ti) at a current time point ti. That is, the currently measured throughput Tput(ti) is a real-time information obtained by the monitoring unit 110 of the firmware FW1 cooperating with the hardware HW1, in a real-time manner.

The QoS-related parameters may include, a resolution Res and a transmission rate Rt, etc. of the video data VD, which are associated with the application AP1. The application AP1 may adjust the resolution Res and a transmission rate Rt of the video data VD based on the currently measured throughput Tput(ti) of the wireless link L12. Furthermore, when adjusting the resolution Res and a transmission rate Rt, a predicted throughput Tput_P(ti) at the current time point ti is also considered. Such as, the monitoring unit 110 (or other computing unit in the firmware FW1, not shown in FIG. 2) is configured to calculate a throughput budget X(ti) of the wireless link L12 at the current time point ti based on the currently measured throughput Tput(ti) and the predicted throughput Tput_P(ti) as equation (1):

$$X ( ti ) = \frac{Tput\_P ( t i ) - T p u t ( t i )}{Tput\_P ( t i )} \qquad ( 1 )$$

The application AP1 may adjust the QoS-related parameters for the video data VD based on the throughput budget X(ti). Such as, when the currently measured throughput Tput(ti) is not close to the predicted throughput Tput_P(ti), the wireless link L12 may have a greater throughput budget X(ti), and the application AP1 may therefore increase the resolution Res and a transmission rate Rt of the video data VD. On the other hand, when the currently measured throughput Tput(ti) is close to the predicted throughput Tput_P(ti) and results in a less throughput budget X(ti), the resolution Res and the transmission rate Rt of the video data VD may be decreased.

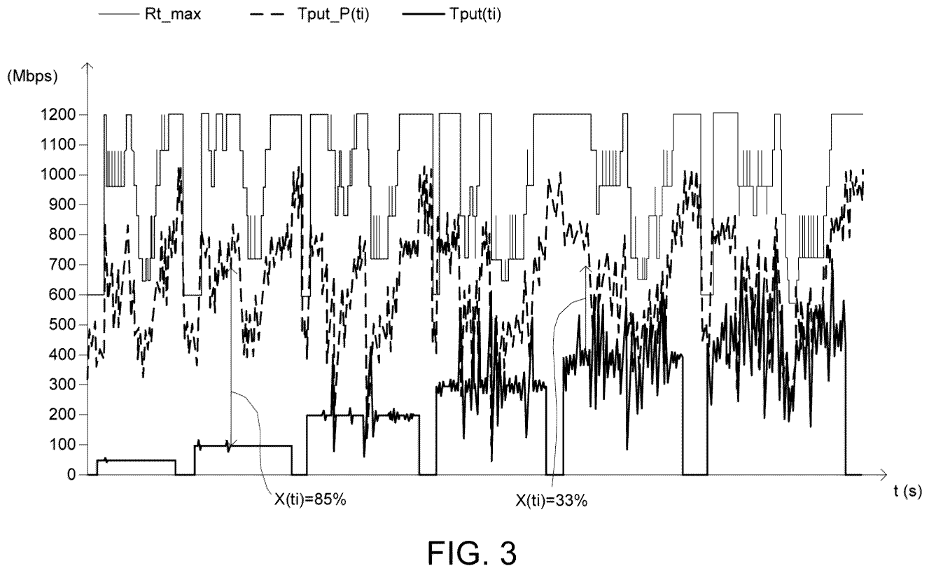

FIG. 3 illustrates a timing diagram showing waveforms of the currently measured throughput Tput(ti), the predicted throughput Tput_P(ti) and a maximum transmission rate Rt_max. Referring to FIG. 3, the maximum transmission rate Rt_max is a theoretically maximum value of the transmission rate Rt which may be achieved by the wireless transceivers 100 and 200. Furthermore, the predicted throughput Tput_P(ti) may be obtained by the monitoring unit 110 or other computing units in the firmware FW1 based on the maximum transmission rate Rt_max. FIG. 3 shows that, the predicted throughput Tput_P(ti) may have a similar changing trend as the maximum transmission rate Rt_max, but slightly lower than the maximum transmission rate Rt_max.

When the currently measured throughput Tput(ti) is 100 Mbps and the predicted throughput Tput_P(ti) is 700 Mbps, the throughput budget X(ti) of the wireless link L12 at the current time point ti may be obtained as 85%, based on the computation as equation (1). The currently measured throughput Tput(ti) of 100 Mbps is not close to the predicted throughput Tput_P(ti) of 700 Mbps, hence the throughput budget X(ti) of 85% may be considered as “loose”. In response to the “loose” throughput budget X(ti) of 85%, the application AP1 may increase the resolution Res and a transmission rate Rt of the video data, such as, increase the resolution Res from “1920×1080 (i.e., 2K)” to “3840×2160 (i.e., 4K)”.

On the other hand, when the currently measured throughput Tput(ti) is 400 Mbps which is closer to the predicted throughput Tput_P(ti) of 600 Mbps, the throughput budget X(ti) of the wireless link L12 may be obtained as 33% and may be considered as “tight”. In response to the “tight” throughput budget X(ti) of 33%, the application AP1 may decrease the resolution Res from “4K” to “2K”.

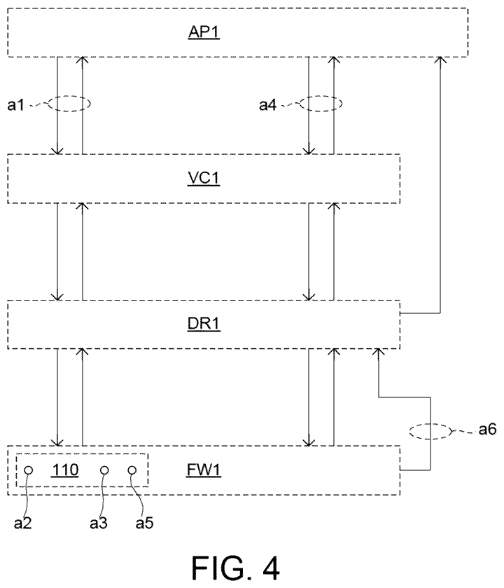

FIG. 4 illustrates a schematic diagram of the SW/FW/HW stack of the source device 1000, which shows the operation of the QoS control method of the disclosure. Referring to FIG. 4, in action a1, the application AP1 issues a command to set parameters of the monitoring unit 110. Such a parameter-setting command is delivered to the firmware FW1 through the layers of the vendor command VC1 and the driver DR1. Then, in action a2, in response to the parameter-setting command for the monitoring unit 110, the firmware FW1 controls the monitoring unit 110 to monitor the throughput Tput of the wireless link L12 in a real-time manner, such that currently measured throughput Tput(ti) is obtained.

Then, in action a3, the firmware FW1 controls the monitoring unit 110 to update a predicted throughput Tput_P(ti) based on a predefined period, e.g., 50 ms (i.e., the predicted throughput Tput_P(ti) is updated per 50 ms). Then, in action a4, the application AP1 obtains the predicted throughput Tput_P(ti) from the firmware FW1. Then, in action a5, the firmware FW1 calculates the throughput budget X(ti) based on the predicted throughput Tput_P(ti) and the currently measured throughput Tput(ti).

Then, in action a6, the firmware FW1 issues a notification indicating a tight state or a loose state of the wireless link L12 based the throughput budget X(t) calculated in action a5. The application AP1 receives the notification and adjusts the QoS-related parameters for the video data VD based on the tight state or the loose state of the wireless link L12. When the received notification indicates the loose state representing the wireless transceivers 100 and 200 have better transmission capability, the application AP1 may enhance or upgrade the QoS-related parameters. On the other hand, when the received notification indicates the tight state representing worse transmission capability of the wireless transceivers 100 and 200, the QoS-related parameters may be downgraded.

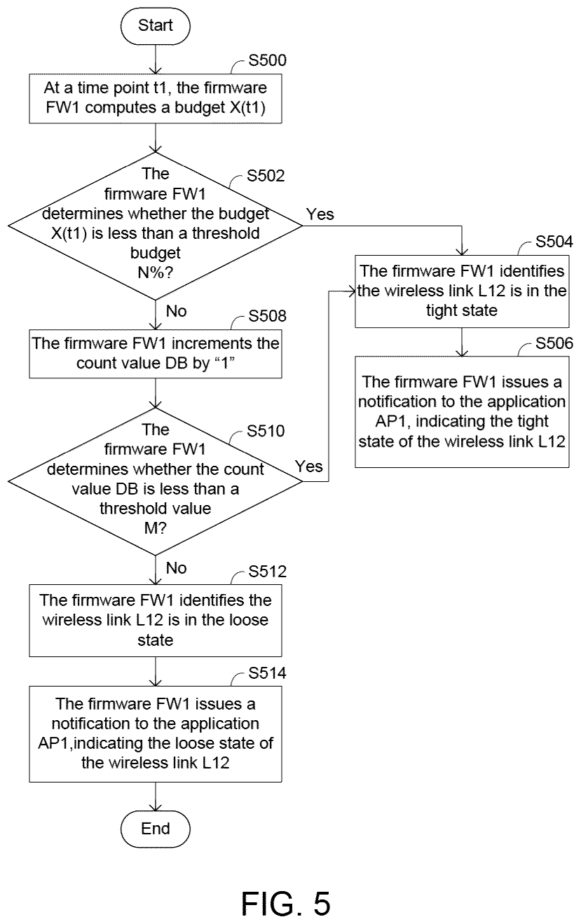

FIG. 5 illustrates a flow diagram of the QoS control method according to an embodiment of the disclosure. Referring to FIG. 5, the method starts at step S500: at a time point t1, the firmware FW1 (by the monitoring unit 110 or other computing units in the firmware FW1) computes a throughput budget X(t1) as equation (1). Then, executing step S502: the firmware FW1 determines whether the throughput budget X(t1) is less than a threshold budget N %. The threshold budget N % is e.g., 20%. When the determining result of step S502 is “Yes” (i.e., the throughput budget X(t1) is less than the threshold budget N % as shown in equation (2)), the firmware FW1 sets a count value DB as “0”. Then, in step S504, the firmware FW1 identifies the wireless link L12 is in the tight state. Then, executing step S506: the firmware FW1 issues a notification indicating the tight state of the wireless link L12, and the notification is sent to the application AP1. In response to the notification, the application AP1 may adjust the QoS-related parameters.

$$X ( t 1 ) < N \% \qquad ( 2 )$$

On the other hand, when the determining result of step S502 is “No” (i.e., the throughput budget X(t1) is greater than or equal to the threshold budget N % as shown in equation (3)), then executing step S508: the firmware FW1 increments the count value DB by “1”. Then, in step S510, the firmware FW1 determines whether the count value DB is less than a threshold value M (the threshold value M is e.g., “20”). When the determining result of step S510 is “Yes”, the method goes to step S504: the firmware FW1 identifies the wireless link L12 is still in the tight state.

$$X ( t 1 ) \geq N \% \qquad ( 3 )$$

On the other hand, when the determining result of step S510 is “No” (i.e., the count value DB is greater than the threshold value M), then executing step S512: the firmware FW1 identifies the wireless link L12 is in the loose state. Then, executing step S514: the firmware FW1 issues a notification to the application AP1, indicating the loose state of the wireless link L12.

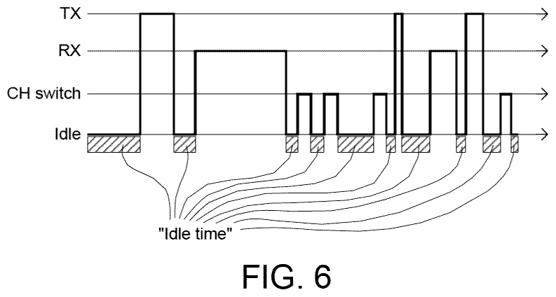

FIG. 6 illustrates a timing diagram showing operations of the transmitter (TX) and the receiver (RX) of the wireless transceiver 100. Referring to both FIGS. 5 and 6, when the TX of the wireless transceiver 100 of the source device 1000 meets the currently measured throughput Tput(ti) of the wireless link L12 of FIG. 5, the wireless link L12 is not in the idle state. On the other hand, in the idle state, the TX of the wireless transceiver 100 is available. That is, “idle time” for the wireless link L12 may be considered as “available time” of the TX of the wireless transceiver 100.

The predicted throughput Tput_P(ti) of FIG. 5 may be obtained (i.e., predicted and estimated) by the monitoring unit 110 or other computing units in the firmware FW1 based on the air status at the current time point ti. The air status may include some parameters of the TX and the RX of the wireless transceiver 100, e.g., (packet error ration, PER) and TX/RX time.

In some comparative examples (not shown in FIGS. 1-6), the upper layer applications may estimate transmission capability of wireless transceivers and connection quality of wireless link based on statistic information, e.g., TX/RX fail count and TX total packets. However, the statistic information are obtained in a statistical manner but not a real-time manner. Furthermore, the upper layer applications cannot obtain detailed lower layer (e.g., layer 2) information. Therefore, the upper layer applications may over-estimate the transmission capability and the connection quality, such that the wireless transceivers may not have enough capability to handle current tasks and hence cause screen freeze/broken and high latency for the video. In other cases, the upper layer applications may under-estimate the transmission capability and the connection quality, such that the wireless transceivers may not achieve their best capability and cause resource wasting.

In contrast to the aforementioned comparative examples, the monitoring unit 110 for the QoS control method of the disclosure may measure the throughput of the wireless link L12 in a real-time manner, so as to obtain the currently measured throughput Tput(ti). That is, the monitoring unit 110 is installed in the lower layer or the bottom layer (i.e., the layer of firmware FW1) to monitor real-time information (i.e., currently measured throughput Tput(ti)), and such real-time information may be actively queried by the application AP1 of the upper layer. The application AP1 can obtain the current transmission capability of the wireless transceivers 100 and 200 based on the currently measured throughput Tput(ti). Then, the application AP1 can adjust the QoS-related parameters base on the throughput budget X(ti) which is computed from the currently measured throughput Tput(ti) and the predicted throughput Tput_P(ti). Therefore, the application AP1 can precisely estimate the current transmission capability of the wireless transceivers 100 and 200 and control the QoS accordingly. Given the well-controlled QoS for the application AP1 in a real-time manner, the wireless transceivers can achieve their best capability for every current moment, and optimal latency and quality for the video can thus be maintained.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for controlling QoS (quality of service) associated with an application, the method comprising:
obtaining a predicted throughput of a wireless link associated with a wireless transceiver;
obtaining a currently measured throughput of the wireless link;
calculating a throughput budget of the wireless link based on the predicted throughput and the currently measured throughput; and
adjusting at least one of a plurality of QoS-related parameters associated with the application base on the throughput budget.

2. The method according to claim 1, wherein the currently measured throughput is a real-time information.

3. The method according to claim 1, wherein the currently measured throughput is obtained by a monitoring unit of a firmware in a real-time manner.

4. The method according to claim 3, wherein the firmware is a lower layer in a stack of a device operating the application, and the application is an upper layer in the stack.

5. The method according to claim 4, wherein the currently measured throughput is related to a transmission capability of the wireless transceiver disposed in the device.

6. The method according to claim 1, wherein the QoS-related parameters at least comprise a resolution and a transmission rate of a video data associated with the application.

7. The method according to claim 6, wherein the resolution or the transmission rate is adjusted by the application.

8. The method according to claim 7, wherein when the wireless link is in a tight state for the throughput budget, the resolution or the transmission rate is decreased by the application.

9. The method according to claim 8, wherein when the throughput budget is less than a threshold budget, it is determined the wireless link is in the tight state.

10. The method according to claim 7, wherein when the wireless link is in a loose state for the throughput budget, the resolution or the transmission rate is increased by the application.

11. The method according to claim 10, wherein when the throughput budget is greater than a threshold budget and a count value is greater than a threshold value, it is determined the wireless link is in the loose state.

12. A method for controlling QoS (quality of service) associated with an application, the method comprising:
obtaining a predicted throughput of a wireless link associated with a wireless transceiver;
obtaining a currently measured throughput which is a real-time information of the wireless link, by a monitoring unit of a firmware in a real-time manner;
calculating a throughput budget of the wireless link based on the predicted throughput and the currently measured throughput; and
adjusting at least one of a plurality of QoS-related parameters associated with the application base on the throughput budget;
wherein the firmware is a lower layer in a stack of a device operating the application, and the application is an upper layer in the stack.

13. The method according to claim 12, wherein the currently measured throughput is related to a transmission capability of the wireless transceiver disposed in the device.

14. The method according to claim 12, wherein the QoS-related parameters at least comprise a resolution and a transmission rate of a video data associated with the application.

15. The method according to claim 14, wherein when the throughput budget is less than a threshold budget and hence determined as a tight state, the resolution or the transmission rate is decreased by the application.

16. The method according to claim 14, wherein when the throughput budget is greater than a threshold budget and a count value is greater than a threshold value and hence determined as a loose state, the resolution or the transmission rate is increased by the application.
